(19) United States
(12) Patent Application Publication
(10) Pub. No.: US 2018/0104787 A1
(43) Pub. Date: Apr. 19, 2018

(54) MACHINE VISE SIDE STOP DEVICE

(71) Applicant: Bruce Richardson, Los Gatos, CA (US)

(72) Inventor: Bruce Richardson, Los Gatos, CA (US)

(21) Appl. No.: 15/728,310

(22) Filed: Oct. 9, 2017

Related U.S. Application Data
(60) Provisional application No. 62/496,345, filed on Oct. 14, 2016.

(51) Int. Cl. B23Q 16/00

(52) U.S. Cl. CPC B23Q 16/001

(57) ABSTRACT

A side stop device used to locate and relocate the left to right, or X direction, position of work material held by a machine vise is disclosed. The side stop device comprises an X direction shaft which fastens the side stop device to the vise, a rear block, a front block, and a Y direction shaft. The X direction shaft and Y direction shaft are fastened to the rear block. The Y direction shaft is fastened to the front block which clamps a small X shaft. The position of the small X shaft is used to locate the work material in the X direction.

This application claims the benefit of U.S. Provisional Application No. 62/496,345, filed Oct. 14, 2016.

### TECHNICAL FIELD

The presently disclosed subject matter relates to a side stop device used to locate and relocate the X direction position of work material held by a machine vise.

### BACKGROUND

Vises are often used to hold work material while it is being processed by a miffing machine. Kurt Manufacturing invented and produces a vise that has become the industry standard. It has interchangeable jaws that can be replaced when damaged or when desired be replaced with different types of jaws. The rear jaw and the top surface of the vise base locate the work material from front to back, the Y axis, and vertically, the Z axis. However, it is crucial to reliably and repeatedly to be able to locate the work material also in the left to right, the X axis direction.

Often, when using a vise or a vise used in a CNC (computer numerical control) machine, it is necessary to perform repetitious machine tool functions on a plurality of substantially identical parts. Therefore, each new work piece must be positioned substantially identically in the same X, Y & Z axes to assure repeatability of the machining operation.

A number of solutions have been proposed, but have not answered the need in the field. In some instances, the side stop effectively limits access of the machine tools or cutting tools to various surfaces of the work material. Yet in other instances, some side stops have a large overhang to the rear that can cause inconvenience and even crashes.

The presently disclosed side stop device is easy to use and effective, it allows repeatability of placement of work material along the X axis without limiting access of machine tools, and it keeps the X direction position when moved out of the way or not in use.

### SUMMARY

In accordance with the present invention, various embodiments of the machine vice side stop device are disclosed. In one embodiment, the present disclosure provides a side stop device to locate the position of work material held by a vise comprising: an X direction shaft comprising fastening bolts wherein the fastening bolts are used to fasten the side stop device to the vise, a rear block which is attachable to the X direction shaft, a Y direction shaft which is attachable to the rear block, at least one front block wherein each said front block is attachable to the Y direction shaft, and at least one small X shaft wherein each said small X shaft is attachable to each front block.

In some embodiments, the X direction shaft comprises two fastening bolts.

In some embodiments, the X direction shaft is positioned in a clamp section of the rear block and said rear block is fastened to the X direction shaft by a clamping screw. Untightening of the clamping screw allows the rear block to be moved and fastened to another position on the X direction shaft, or to be rotated around the X direction shaft, or to be removed from the X direction shaft.

In some embodiments, the Y direction shaft is positioned in an opening in the rear block and fastened to the said block by a clamping screw. Untightening of the clamping screw allows the Y direction shaft to be moved and fastened to the rear block in another position on the Y direction shaft, or to be removed from the rear block.

In some embodiments, the Y direction shaft is positioned in an opening in the front block and fastened to the front block by a clamping screw. Untightening of the clamping screw allows the front block to be moved and fastened in another position on the Y direction shaft or the front block can be removed from the Y direction shaft.

In some embodiments, a clamping screw fastens the small X shaft to the front block. Untightening of the clamping screw allows the small X shaft to be moved and fastened in another position in the X direction or to be removed from the front block.

In some embodiments, the front block and small X shaft are rotated in accordance with the rotation of the rear block around the X direction shaft.

In some embodiments, all the clamping screws are oriented in the same direction to allow for an easy access.

In some embodiments, the X direction shaft comprises a collar or a spacer to locate the rear block X location, thus allowing the repositioning of the rear block to the same, previously located, X location on the X direction shaft after the rear block was removed from X direction shaft.

In some embodiments, the entire side stop device, or clamp, is below the top of the small X shaft.

### BRIEF DESCRIPTION OF THE DRAWINGS

FIG. 1: illustrates a vise holding work material.

FIG. 2: illustrates the presently disclosed side stop device wherein it is attached to a vise.

FIG. 3: illustrates the presently disclosed side stop device wherein it is attached to a vise, depicting the location of the work stop.

FIG. 4: illustrates a top view of the presently disclosed side stop device wherein it is attached to a vise, depicting the X and Y directions.

FIG. 5: illustrates the presently disclosed side stop device.

FIG. 6: illustrates the presently disclosed side stop device.

FIG. 7: illustrates a side view of the presently disclosed side stop device wherein it is attached to a vise, depicting rotation of the Y direction shaft.

FIG. 8: illustrates the presently disclosed side stop device.

FIG. 9: illustrates the presently disclosed side stop device.

FIG. 10: illustrates a partial side view of the presently disclosed side stop device, depicting the location of the work stop by the small X shaft.

FIG. 11: illustrates a partial top view of the presently disclosed side stop device wherein it is attached to a vise, depicting movement of the front block in the Y direction.

FIG. 12: illustrates a partial top view of the presently disclosed side stop device wherein it is attached to a vise.

FIG. 13: illustrates the presently disclosed side stop device, depicting movement of the small X shaft in the X direction.

FIG. 14: a partial view illustrating the small X shaft and front block fastened to the Y direction shaft.

FIG. 15: illustrates a side section view of the presently disclosed side stop device.

FIG. 16: illustrates a partial top view of the presently disclosed side stop device wherein it is attached to a vise. In the embodiment shown, the rear block is wider than the front block.

FIG. 17: partial view illustrating the presently disclosed side stop device wherein it is attached to a vise. In the embodiment shown, a collar is clamped to the X direction shaft.

FIG. 18: illustrates a side view of the presently disclosed side stop device wherein it is attached to a vise, and wherein the location of the top surface of the Y direction shaft is below the vise base.

FIG. 19: illustrates the presently disclosed side stop device wherein it is attached to a vise. In the embodiment shown, the Y direction shaft has a hexagonal profile.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a side stop device to locate the left to right, or the X direction, the position of work material held by a vise. The side stop device comprises a rear block, an X direction shaft comprising fastening bolts used to fasten the side stop device to the vise, Y direction shaft, at least one front block and at least one small X shaft. The X direction shaft and the Y direction shaft are clamped to the rear block. Each said front block is fastened to the Y direction shaft, and each said small X shaft is fastened to each front block. The X direction position of the small X shaft determines the work stop; which is the X direction position of the work material in relation to cutting, or any other, tools.

All of the clamping screws holding together the different parts of the side stop device are oriented in the same direction. In some embodiments, all of the clamping screws can be adjusted with one size hex key. This allows for an easy access to adjusting settings, removing or replacing components, etc. For example, after the side stop device is fastened to a vise by the X direction shaft tightening bolts, the position of the rear block on the X direction shaft can be easily adjusted by untightening the rear block clamping screw, moving the rear block to a desired position in the X direction and fastening it to the X direction shaft by tightening the rear block clamping screw. The Y position of the front block may be adjusted by either untightening the Y direction shaft clamping screw, sliding the Y direction shaft into a desired position through the opening in the rear block, and tightening the Y direction shaft clamping screw, or by untightening the front block clamping screw, moving the front block to a desired Y location on the Y direction shaft, and tightening the front block clamping screw to fasten the front block to said Y position. The X direction position of the small X shaft may be adjusted by untightening the small X shaft clamping screw, moving the small X shaft to a desired X position which will mark the work stop, and re-tightening the small X shaft clamping screw to fasten the small X shaft to the chosen X direction position. The position of the small X shaft and hence the work stop can be also adjusted height-wise (Z axis) by untightening the rear block clamping screw, rotating the rear block around the X direction shaft to a desired position height-wise, and re-tightening the rear block clamping screw to fasten the rear block to said position. Therefore, the Y direction position can be altered without affecting the X direction position or the work stop. Thus, the side stop device allows to an easy adjustment to locate the X direction position of work material that varies in width, length and height. In addition, the presently disclosed side stop device allows a user to easily relocate a previously determined X direction position after the side stop device, or components of it, had been removed from the vise, or a different piece of work material has been clamped to the vise. In fact, a user can completely remove (or slide out) the front elements of the side stop device, such as the Y direction shaft and front block, out of the way for a new setup and restore the same X direction location when going back to the previous setup.

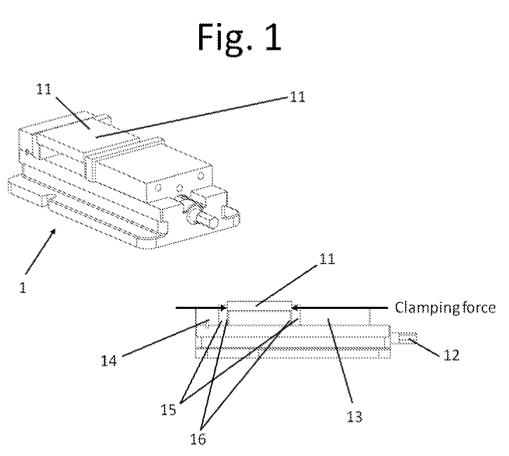

Referring now to FIG. 1, a vise is shown, holding work material (11). The presently disclosed side stop device is designed to work with vises, as generally depicted in FIG. 1. Such vises are, for example, vises manufactured by Kurt Manufacturing which have become the industry standard. The instant side stop device generally works with Kurt type vises on a Bridgeport or CNC machine. However, one skilled in the art will appreciate that the presently enclosed side stop device may be used with any type or make of vise to which it can be fitted. Going back to FIG. 1, the work material (11) is clamped by the replaceable jaws (15) front to rear and by the parallels (16) at the bottom. The vise comprises a rear fixed jaw (14), and a main clamping jaw (13). The main clamping jaw (13) moves in the Y direction and is controlled by the clamp actuating shaft (12). The clamping force exerted on the work material (11) is depicted in FIG. 1 by two arrows.

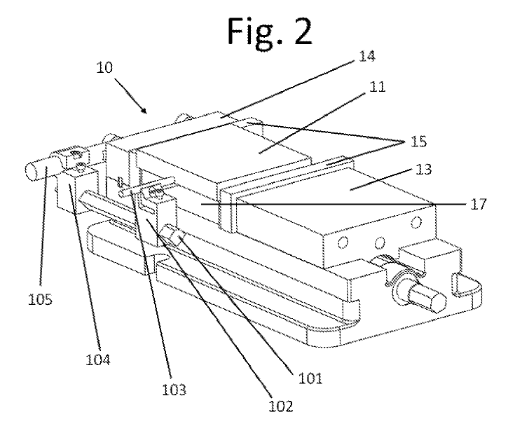

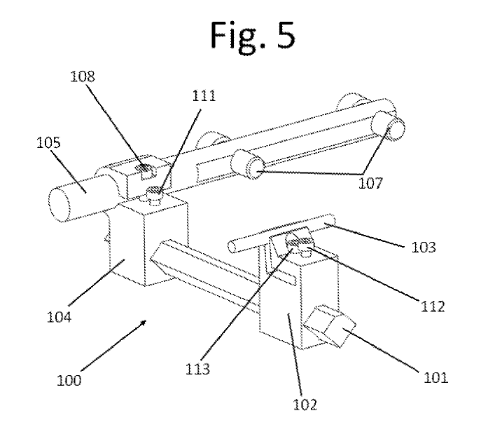

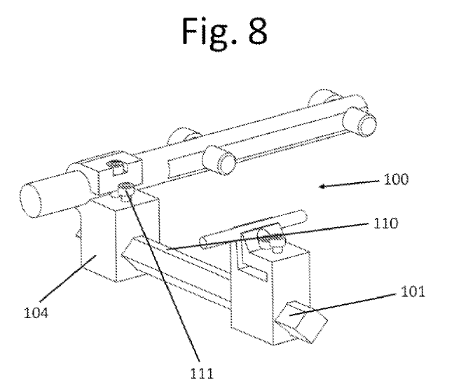

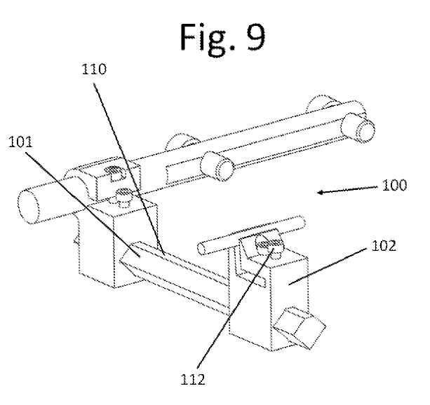

Referring to FIG. 2, the presently disclosed side stop device wherein it is attached to a vise (10) is shown. The X direction shaft (105) secures the side stop device to the vise. The rear block (104) is clamped to the X direction shaft (105). The Y direction shaft (101) is inserted through an opening in the rear block (104) and is fastened in place (as shown in at least FIGS. 5 and 8). The Y direction shaft (101) is also inserted through an opening in the front block (102) and is fastened in place (as shown in at least FIGS. 5 and 9). A small X shaft (103) is clamped to the front block.

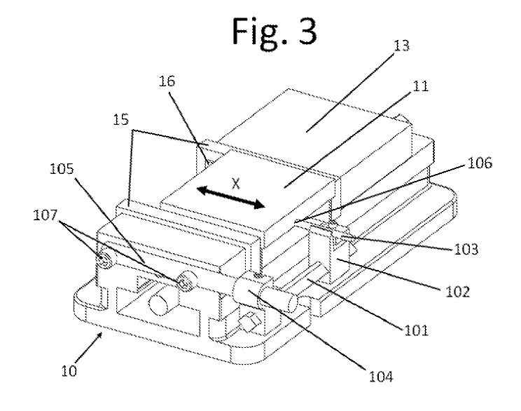

FIG. 3 shows the presently disclosed side stop device wherein it is attached to a vise (10) and illustrates the position of the small X shaft (103) relative to the work material (11). The work stop (106) locates the position of the work material (11) from left to right, in the X direction. This allows for the insertion of pieces of work material (11) to the same X location.

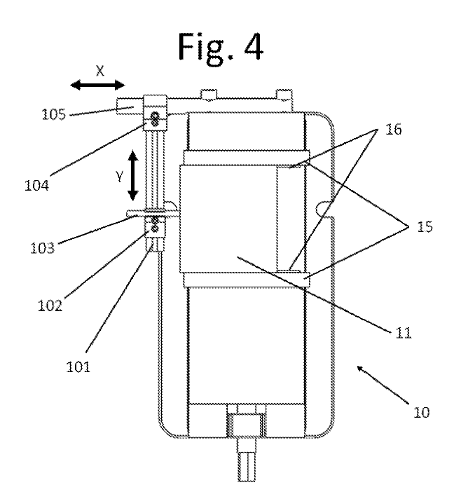

FIG. 4 shows a top view of the presently disclosed side stop device wherein it is attached to a vise (10) and depicts the X and Y directions, represented by a left-right and up-down arrows, respectively.

FIG. 5 illustrates the presently disclosed side stop device (100). The fastening bolts (107) fasten the side stop devise to the vise (not shown). The rear block clamping screw (108) fastens the rear block (104) to the X direction shaft (105). The Y direction shaft clamping screw (111) fastens the Y direction shaft (101) to the rear block (104). The front block clamping screw (112) fastens the front block (102) to the Y direction shaft (101), while the small X shaft clamping screw (113) fastens the small X shaft (103) to the front block (102). All of the clamping screws of the presently disclosed side stop device (100) are easily accessed from the same direction which allows for convenient adjustments.

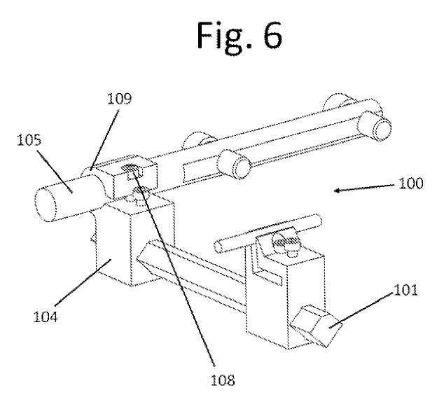

Referring to FIG. 6, an illustration of the presently disclosed side stop device (100) is shown. The rear block clamping screw (108) fastens the rear block to the X direction shaft (105). It does so by bending the clamp section around the X direction shaft. When the rear block clamping screw (108) is untightened, the rear block can be either rotated around the x direction shaft (105) or moved in the X direction.

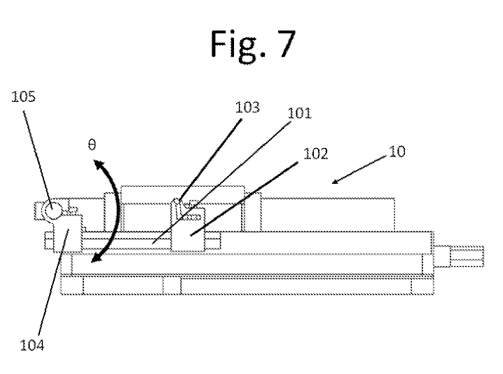

FIG. 7 illustrates a side view of the presently disclosed side stop device wherein it is attached to a vise (10). By untightening the rear block clamping screw, (108, not seen in this view) the rear block (104), and therefore, the Y direction shaft (101), the front block (102) and the small X shaft (103) can be rotated up or down. This allows for the adjustment of the height of the small X shaft (103). This is done to compensate for different heights of the work material. The arrow depicts the rotation movement of the rear block (104) around the X direction shaft (105). One skilled in the art will notice that the small X shaft (103) is clamped to the top of the front block (102), which reduces tool interference. The small X shaft (103) is the highest part of the stop device (100).

FIG. 8 shows the presently disclosed side stop device (100). The Y direction shaft clamping screw (111) fastens the Y direction shaft to the rear block (104). The Y direction shaft clamping screw (111) applies force to the top flat surface (110) of the Y direction shaft (101). When the Y direction shaft clamping screw (111) is untightened, the Y direction shaft (101) can be moved in the Y direction or be removed from the rear block (104).

Referring now to FIG. 9, the presently disclosed side stop device (100) is illustrated. The front block clamping screw (112) fastens the front block (102) to the Y direction shaft (101). The front block clamping screw (112) applies force to the top flat surface (110) of the Y direction shaft (101). When the front block clamping screw (112) is untightened, the front block (102) can be moved in the Y direction or the front block (102) can be removed from Y direction shaft (101).

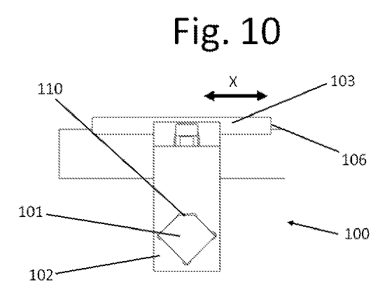

Referring to FIG. 10, a partial side view of the presently disclosed side stop device (100) is illustrated. The square, or squarish, shape of the Y direction shaft (101) and, accordingly, the square, or squarish, holes in the front and rear blocks (102 and 104, respectively) maintains the X position of the work stop (106) when the Y location of the front block (102) is changed. The Y location might be changed for a sized piece of work material. The arrow depicts possible X direction movement of the small X shaft (103).

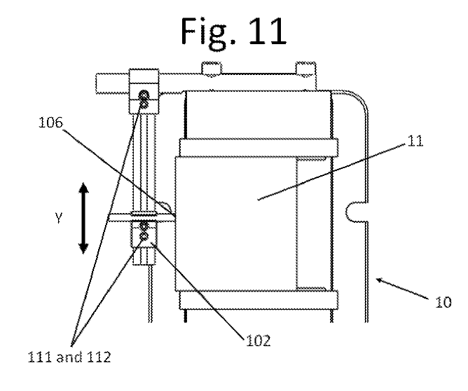

Referring to FIG. 11, a top partial view of the presently disclosed side stop device wherein it is attached to a vise (10). By untightening either the Y direction shaft clamping screw (111) or the front block clamping screw (112) the front block (102) and the small X shaft (103) can be moved in the Y direction. When untightening the Y direction shaft clamping screw (111) it is done by moving the Y direction shaft (101), and therefore, the front block (102) fastened to it, in the Y direction. When the front block clamping screw (112) is untightened, the front block (102) can be moved to a desired position on the Y direction shaft and fastened to it. Using either of methods mentioned above, the front block (102) and the small X shaft (103) can be moved without altering the X orientation of the work stop (106).

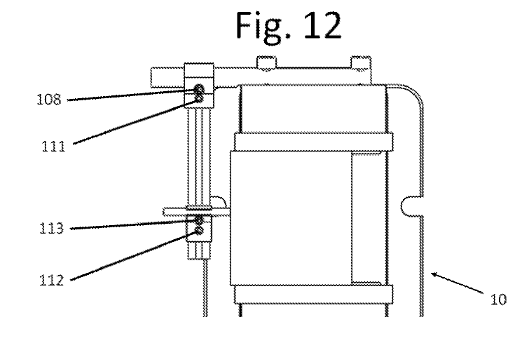

FIG. 12 illustrates a top partial view of the presently disclosed side stop device wherein it is attached to a vise (10). All of the clamping screws (108, 111, 113 and 112) are oriented in the same direction. This allows for easy access to the clamping screws. Access to the vise is often limited when vises are used in a CNC (computer numerical control) machine. CNC machines have an enclosure to contain cooling and chips, which limits access to the machine. Further, many vises are often are arranges next to one another in a CNC machine which further restricts access to specific elements, therefore the easy top access to clamping screws as featured by the present side stop device (100) a significant improvement.

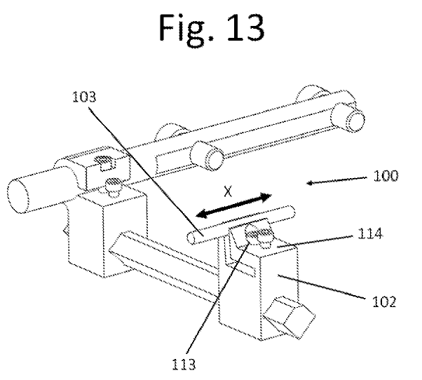

Referring to FIG. 13, the small X shaft clamping screw (113) fastens the small X shaft (103) to the front block (102). The small X shaft clamping screw (113) applies force to the top flat surface of the lever section (114). When the small X shaft clamping screw (113) is untightened, the small X shaft (103) can be moved in the X direction or the small X shaft can be removed.

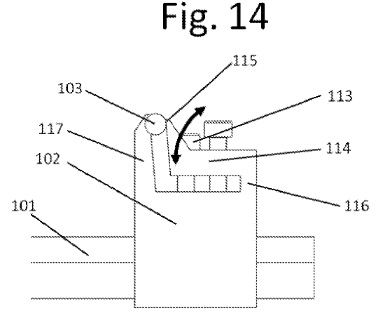

FIG. 14 a side view illustrating the small X shaft (103) and front block (102) fastened to the Y direction shaft (101, partially shown). When the small X shaft clamping screw (113) is tightened, the lever section (114) of the front block (102) rotates around the strain area (116) of the front block (102) and clamps the small X shaft (103) against the stop member (117).

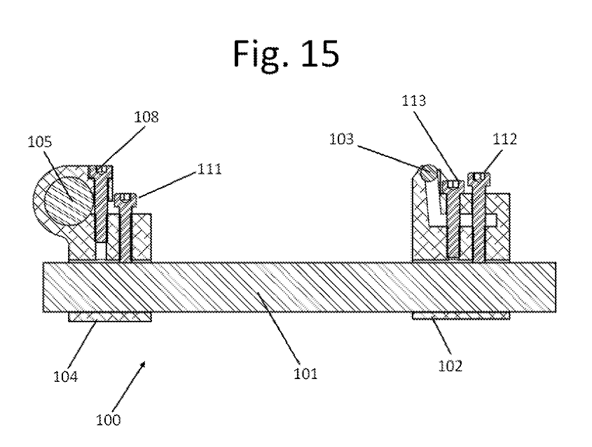

FIG. 15 depicts a side section view of the presently disclosed side stop device (100). The clamping of the X direction shaft (105) to the rear block (104) by the rear block clamping screw (108) is depicted. The Y direction shaft (101) is clamped to the rear block (104) and front block (102) by the Y direction shaft clamping screw (111) and the front block clamping screw (112), respectively. The small X shaft (103) is clamped to the front block (104) by the small X shaft clamping screw (113).

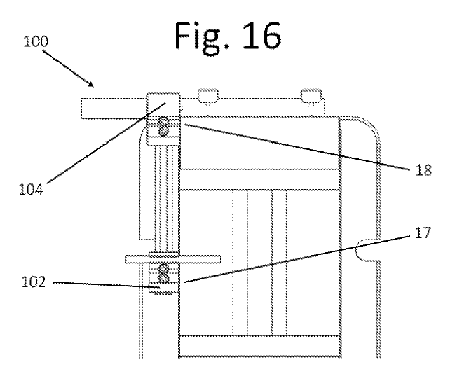

FIG. 16 illustrates a top partial view of the presently disclosed side stop device wherein it is attached to a vise (10). In the embodiment shown, the rear block (104) is wider than the front block (102). When the rear block (104) is wider than the front block (102), a gap is formed between the front block (102) and vise base. This gap allows free movement of the front block, upon untightening of the front block clamping screw (112) in the Y direction. By locating the rear block (104) up against the rear vise block (18) during one setup, the front block (102) can be easily removed and relocated when desired to the same X location.

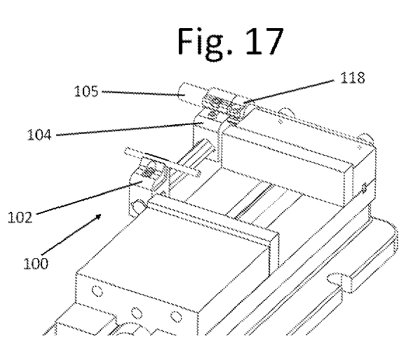

FIG. 17 illustrates a partial view of the presently disclosed side stop device wherein it is attached to a vise (10). In the embodiment shown, a collar (118) is clamped to the X direction shaft (105). In some embodiments, a collar (118) or a spacer (not shown), on the X direction shaft (105) is used to locate the rear block (104) X location. This allows the relocation of the rear block (104) to the same X location, after the rear block (104) had been removed and/or replaced for different setups.

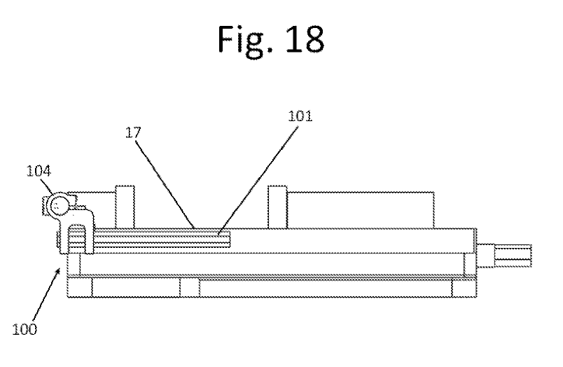

FIG. 18: illustrates a side view of the presently disclosed side stop device wherein it is attached to a vise (10), showing that the top surface of the Y direction shaft (101) is below the vise base (17). By locating the top surface of the Y direction shaft (101) below the vise base (17), work material (11) (not shown) held by the vise can extend over the Y direction shaft (101), without being obstructed by it, when the front block (104) is removed. This allows for removal of only the front block (104) when changing from one setup to another.

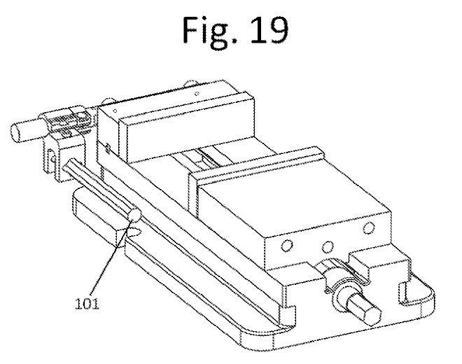

FIG. 19: illustrates the presently disclosed side stop device wherein it is attached to a vise (10). In some embodiments, the Y direction shaft (101) has a hexagonal profile. A hexagonal shaft profile of the Y direction shaft (101) allows for the front block (104) to be mounted in any one of four orientations around the centerline of the Y direction shaft (101). A person skilled in the art will appreciate the Y direction shaft (101) may be fashioned in any shape that will allow it to be secured to the front and rear blocks (104 and 102, respectively) in a reliably repeatable manner. Such shapes may be, but are not limited to, triangle, pentagon or hexagon. One skilled in the art will also appreciate that the openings in the rear block (102) and front block (104) may be shaped in any way to match the profile of the Y direction shaft (101).

I claim:

1. A side stop device to locate the position of work material held by a vise comprising:
an X direction shaft comprising fastening bolts wherein said fastening bolts are used to fasten the side stop device to the vise;
a rear block, wherein the rear block is attachable to the X direction shaft;
a Y direction shaft, wherein the Y direction shaft is attachable to the rear block;
at least one front block, wherein each front block is attachable to the Y direction shaft, and;
at least one small X shaft, wherein each small X shaft is attachable to each front block.

2. The side stop device of claim 1, wherein the X direction shaft comprises two fastening bolts.

3. The side stop device of claim 2, wherein the X direction shaft is positioned in a clamp section of the rear block and said rear block is fastened to the X direction shaft by a clamping screw, and wherein untightening of said screw allows the rear block to be moved and fastened to another position on the X direction shaft, to be rotated around the X direction shaft or to be removed from the X direction shaft.

4. The side stop device of claim 3, wherein the Y direction shaft is positioned in an opening in the rear block and fastened to said block by a clamping screw, and wherein untightening of said screw allows the Y direction shaft to be moved and fastened to the rear block in another position on the Y direction shaft or to be removed from the rear block.

5. The side stop device of claim 4, wherein the Y direction shaft is positioned in an opening in the front block and fastened to said block by a clamping screw, and wherein untightening of said screw allows the front block to be moved and fastened in another position on the Y direction shaft or the front block can be removed from the Y direction shaft.

6. The side stop device of claim 5, wherein a clamping screw fastens the small X shaft to the front block, and wherein untightening of said screw allows the small X shaft to be moved and fastened in another position in the X direction or to be removed from the front block.

7. The side stop device of claim 6, wherein the front block and small X shaft are rotated in accordance with the rotation of the rear block around the X direction shaft.

8. The side stop device of claim 7, wherein all the clamping screws are oriented in the same direction to allow for an easy access.

9. The side stop device of claim 8, wherein the X direction shaft comprises a collar or a spacer to locate the rear block X location, thus allowing the repositioning of the rear block to the same X location on the X direction shaft after said block was removed from said shaft.

10. The side stop device of claim 1, wherein the entire clamp is below the top of the small X shaft.
